(19) United States
(12) Patent Application Publication
(10) Pub. No.: US 2008/0049391 A1
(43) Pub. Date: Feb. 28, 2008

(54) BAR TYPE PORTABLE TERMINAL

(75) Inventor: Kwan-Woo SHIN, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/846,228

(22) Filed: Aug. 28, 2007

(30) Foreign Application Priority Data
Aug. 28, 2006 (KR) 2006-0081444

(51) Int. Cl. G06F 1/16

(52) U.S. Cl. 361/681

(57) ABSTRACT

Provided is a bar type portable terminal including a body; a main Liquid Crystal Display (LCD) module installed on a front surface of the body; at least one slide cover sliding on a back surface of the body in a longitudinal direction of the bar type portable terminal; a slave LCD module installed on the back surface and exposed when the at least one slide cover is opened; and at least one speaker installed in the at least one slide cover.

### PRIORITY

This application claims priority under 35 U.S.C. § 119 to an application filed in the Korean Intellectual Property Office on Aug. 28, 2006 and assigned Serial No. 2006-81444, the contents of which are incorporated herein by reference.

### BACKGROUND OF THE INVENTION

1. Field of the Invention

The present invention relates generally to a bar type portable terminal, and in particular, to a bar type portable terminal providing a basic telephone call function and effectively realizing various multimedia contents through which a user can listen to music, watch movies, etc., so as to improve user convenience.

2. Description of the Related Art

With the development of the electronics and telecommunications industry, portable terminals have become increasingly compact and light but have performed more functions. For example, speakers have been installed to realize various chord melodies, and multimillion-pixel color display devices have been realized. Also, besides basic telephone call functions, music playing functions have been realized in portable terminals through MP3 players. In addition, various game contents, movies, etc. have been provided using the multimillion-pixel color display devices. Studies have been made to further develop these functions.

In general, portable terminals are broadly classified into bar type portable terminals, folder type portable terminals, and slide type portable terminals. The slide type portable terminals have been widely used, but the bar type portable terminals have still been regularly used to meet various preferences of users.

A bar type portable terminal as described above typically does not include an additional sub-body such as a folder or slide body which performs an opening operation at a main body. When the bar type portable terminal is provided with an additional sub-body, the additional sub-body is only to provided to make the bar type portable terminal beautiful. The main body must perform various functions of the bar type portable terminal. Thus, the main body must include a plurality of key buttons which are data input units, a display device which is a data output unit, a microphone which is a telephone transmitter, a speaker which is a telephone receiver, etc.

However, a conventional bar type portable terminal having a structure as described above does not satisfy current user preferences requiring complicated, various functions, e.g., playing music, showing movies, providing game contents, etc.

### SUMMARY OF THE INVENTION

An aspect of the present invention is to substantially solve at least the above problems and/or disadvantages and to provide at least the advantages below. Accordingly, an aspect of the present invention is to provide a bar type portable terminal realized to provide optimal use environments suitable for various functions besides a telephone call function.

Another aspect of the present invention is to provide a bar type portable terminal realized to allow a user to listen to music in stereo.

A further aspect of the present invention is to provide a bar type portable terminal realized to use an additional wider Liquid Crystal Display (LCD) module and allow a user to listen to music in stereo and concurrently to see high-quality moving pictures.

A still further aspect of the present invention is to provide a bar type portable terminal realized to minimize a bulk thereof and further effectively perform various additional functions.

According to one aspect of the present invention, there is provided a bar type portable terminal including a main body having a front surface on which a main LCD module is installed; at least one slide cover sliding on a back surface of the main body in a longitudinal direction of the bar type portable terminal; and a slave LCD module installed on the back surface of the main body which is exposed when the at least one slide cover is opened.

### BRIEF DESCRIPTION OF THE DRAWINGS

The above and other aspects, features and advantages of the present invention will become more apparent from the following detailed description when taken in conjunction with the accompanying drawings in which:

FIG. 1 is a perspective view of a front surface of a bar type portable terminal according to the present invention;

FIG. 2 is a perspective view of a back surface of the bar type portable terminal according to the present invention;

FIG. 3 is a perspective view illustrating open state of slide covers of the bar type portable terminal according to the present invention;

FIG. 4 is a cross-sectional view of an internal structure of the bar type portable terminal according to the present invention; and

FIG. 5 is a schematic cross-sectional view of a slide cover simultaneously opening unit of the bar type portable terminal according to the present invention.

### DETAILED DESCRIPTION OF THE PREFERRED EMBODIMENTS

Preferred embodiments of the present invention will be described herein below with reference to the accompanying drawings. In the following description, for clarity and conciseness, well-known functions or constructions are not described in detail.

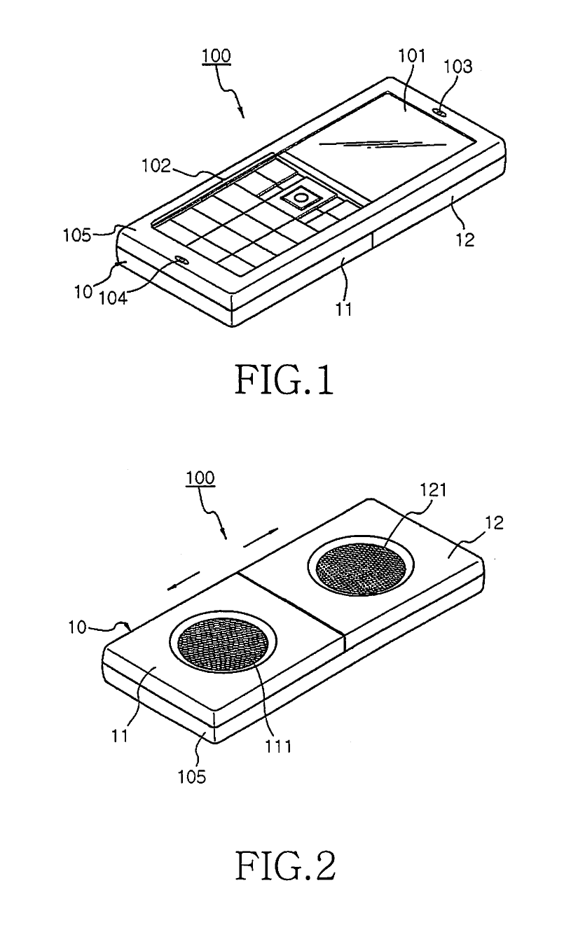

FIG. 1 is a perspective view of a front surface of a bar type portable terminal 100 according to the present invention. Referring to FIG. 1, the bar type portable terminal 100 includes a main body. The main body includes an upper case frame 105 and a lower case frame 10.

The upper case frame 105 is used as the front surface of the bar type portable terminal 100, and a main Liquid Crystal Display (LCD) module 101 is installed on the upper case frame 105. A plurality of key buttons 102 are installed next to the main LCD module 101 to be used as data input units. A microphone 104 is installed at one end of the upper case frame 105 and next to the plurality of key buttons 102 to be used as a telephone transmitter, and a speaker 103 is installed at another end of the upper case frame 105 and next to the main LCD module 101 to be used as a telephone receiver. The microphone 104 and the speaker 103 may be mainly used for basic speech communications.

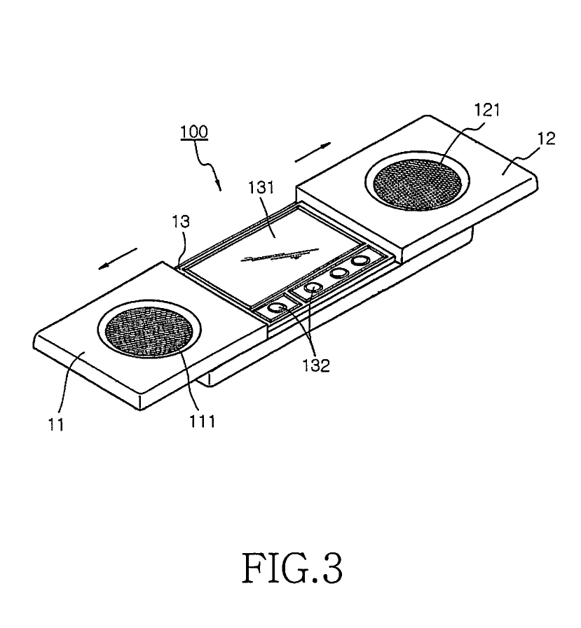

According to the present invention, the lower case frame 10 includes slide covers 11 and 12 which are movably installed. The slide covers 11 and 12 may be installed to be respectively opened to the left and right from a middle of the lower case frame 10. For convenience, the slide covers 11 and 12 are referred to as first and second slide covers, respectively. If the first and second slide covers 11 and 12 are opened, the first and second slide covers 11 and 12 may operate as the lower case frame 10 except for exposing a back surface 13 of the main body (FIG. 3).

Although not shown, the first and second slide covers 11 and 12 may include well-known guide units. Thus, the first slide covers 11 and 12 may include guide ribs which are formed at the first and second slide covers 11 and 12 or the main body and guide slits which are installed at the main body or the first and second slide covers 11 and 12 to guide the guide ribs.

Although the first and second slide covers 11 and 12 are presented in the present application, one slide cover may be installed to be opened in a longitudinal direction of the bar type portable terminal 100. In this case, two speakers may be installed in the slide cover to perform stereo functions. The two speakers will be described later.

FIG. 2 is a perspective view of a back surface of the bar type portable terminal 100. The first and second slide covers 11 and 12 respectively slide to the left and right (in directions indicated by arrows of FIG. 2) from the middle of the lower case frame 10 so as to open the lower case frame 10 by a predetermined length. For example, sliding distances of the first and second slide covers 11 and 12 may not exceed ½ of a total length of the first and second slide covers 11 and 12, so that the first and second slide covers 11 and 12 smoothly slide.

First and second speakers 111 and 121 are respectively installed in the first and second slide covers 11 and 12. Thus, a user can listen to music in stereo through the first and second speakers 111 and 121. The first and second speakers 111 and 121 may be respectively installed level to or lower than a sliding surface of the first and second slide covers 11 and 12 in order to prevent the first and second speakers 111 and 121 from damage due to interference with moving objects such as the first and second slide covers 11 and 12.

FIG. 3 is a perspective view illustrating open states of the first and second slide covers 11 and 12 of the bar type portable terminal 100. When the first and second slide covers 11 and 12 are opened, a slave LCD module 131 having a predetermined width may be installed on the exposed back surface 13 of the main body. The slave LCD module 131 may be a normal LCD module but is not limited thereto. For example, a touch screen may be installed as the slave LCD module 131. A plurality of key buttons 132 are installed next to the slave LCD module 131. Thus, manipulation convenience can be provided using the slave LCD module 131 without manipulating the plurality of key buttons 102 installed on the front surface of the bar type portable terminal 100. The slave LCD module 131 and the plurality of key buttons 132 are installed lower than the back surface 13 of the main body so as to be prevented from being damaged by scratches or the like caused by opening and closing operations of the first and second slide covers 11 and 12.

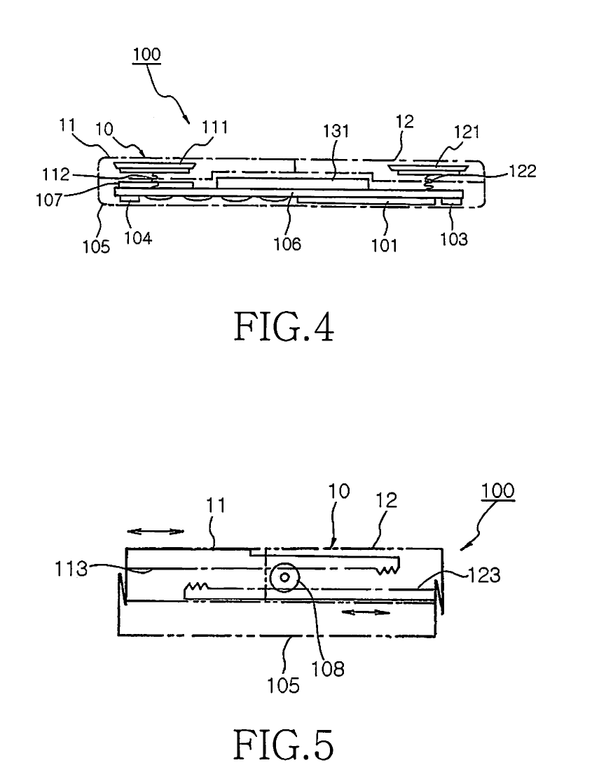

FIG. 4 is a cross-sectional view of an internal structure of the bar type portable terminal 100. A main board 106 is installed inside the main body. The main LCD module 101 may be installed on the main board 106 toward the lower case frame 105, and the microphone 104 and the speaker 103 may be mounted on opposite portions of the main board 106.

The slave LCD module 131 may be installed on an opposite surface of the main board 106 to a surface of the main board 106 on which the main LCD module 101 is installed. The first and second speakers 111 and 121 installed in the first and second slide covers 11 and 12 may be electrically connected to the main board 106 through electrical connection units 112 and 122 such as predetermined Flexible Printed Circuit Boards (FPCBs), session cables, or the like. Here, extra portions of the electrical connection units 112 and 122 are left to exclude possibility of short-circuit, etc. within sliding ranges of the first and second slide covers 11 and 12. The bar type portable terminal 100 according to the present invention adopts an internal rechargeable battery 107, which utilizes a battery pack mount space without increasing an entire bulk of the bar type portable terminal 100.

In the present invention, the first and second slide covers 11 and 12 may slide separately or simultaneously. If the first and second slide covers 11 and 12 slide simultaneously, a slide cover simultaneously opening unit may be further installed as shown in FIG. 5 so as to open and close both of the covers 11 and 12 when a user slides open and close either one of the covers.

FIG. 5 is a schematic cross-sectional view of the slide cover simultaneously opening unit of the bar type portable terminal 100. First and second rack gears 113 and 123 are respectively installed on inner surfaces of the first and second slide covers 11 and 12 in a longitudinal direction of the bar type portable terminal 100. The first and second rack gears 113 and 123 may be respectively installed on allowed spaces of the inner surfaces of the first and second slide covers 11 and 12. A pinion gear 108 is installed in an appropriate position of the main body so as to idly rotate. The pinion gear 108 is interposed between the first and second rack gears 113 and 123 to gear the first and second rack gears 113 and 123 with each other so as to operate the first rack gear 113 together with the second rack gear 123.

If a space is allowed in the bar type portable terminal 100, a driving motor (not shown) may be further installed to rotate the pinion gear 108. The driving motor may includes a reduction gear (not shown) which reduces a number of rotations of the pinion gear 108 and increases a rotating force of the pinion gear 108. Thus, a terminal controller (not shown) senses an input of a key manipulation of a user and then rotates the driving motor in one direction to simultaneously operate the first and second rack gears 113 and 123 so as to automatically open and close the first and second slide covers 11 and 12.

In accordance with the present invention as described above, a bar type portable terminal can include an additional LCD module with an increase of a bulk thereof minimized. The bar type portable terminal can also include speakers through which a user can listen to music in stereo, so as to meet diversifying demands of the user. In addition, the bar type portable terminal can assist the user to further effectively use various functions added thereto.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A bar type portable terminal comprising:
a body;
a main Liquid Crystal Display (LCD) module installed on a front surface of the body;
at least one slide cover slidably installed on a back surface of the body in a longitudinal direction of the bar type portable terminal; and
a slave LCD module installed on the back surface, the slave LCD being exposed when the at least one slide cover slides to an open state.

2. The bar type portable terminal of claim 1, wherein the at least one slide cover includes a first and a second slide covers which respectively slide in left and right directions from a middle of the back surface to the open state.

3. The bar type portable terminal of claim 1, further comprising at least one manipulation key button installed on the back surface.

4. The bar type portable terminal of claim 3, wherein the slave LCD module and the at least one manipulation key button are exposed level to or lower than the back surface.

5. The bar type portable terminal of claim 1, further comprising at least one speaker installed in the at least one slide cover, wherein a portion of the at least one speaker is exposed.

6. The bar type portable terminal of claim 2, wherein first and second speakers are respectively installed on outer surfaces of the first and second slide covers.

7. The bar type portable terminal of claim 6, wherein the first and second speakers are exposed level to or lower than the outer surfaces of the first and second slide covers.

8. The bar type portable terminal of claim 2, wherein the first and second slide covers slide separately.

9. The bar type portable terminal of claim 2, further comprising a slide cover simultaneously opening unit simultaneously opening and closing one of the first and second slide covers when the other one of the first and second slide cover is opened and closed.

10. The bar type portable terminal of claim 9, wherein the slide cover simultaneously opening unit comprises:
a first rack gear installed on an inner surface of the first slide cover in the longitudinal direction of the bar type portable terminal;
a second rack gear installed on an inner surface of the second slide cover in the longitudinal direction of the bar type portable terminal; and
a pinion gear installed in a predetermined position of the main body to idly rotate, wherein the pinion gear is interposed between the first and second rack gears to slide the first and second slide covers in opposite directions.

11. The bar type portable terminal of claim 10, further comprising a driving motor which rotates the pinion gear according to a key input of a key button installed in a predetermined location of the bar type portable terminal so as to automatically open and close the first and second slide covers.

12. The bar type portable terminal of claim 1, further comprising a power supply unit which is an internal rechargeable battery mounted inside the bar type portable terminal.
